(19) United States
(12) Patent Application Publication
(10) Pub. No.: US 2020/0249489 A1
(43) Pub. Date: Aug. 6, 2020

(54) SCREEN FRAME, DISPLAY SCREEN MODULE AND TERMINAL

(71) Applicant: BEIJING XIAOMI MOBILE SOFTWARE CO., LTD., Beijing (CN)

(72) Inventor: CHIAFU YEN, Beijing (CN)

(73) Assignee: BEIJING XIAOMI MOBILE SOFTWARE CO., LTD., Beijing (CN)

(21) Appl. No.: 16/681,780

(22) Filed: Nov. 12, 2019

(30) Foreign Application Priority Data
Jan. 31, 2019 (CN) 201910101420.1

(51) Int. Cl. G02B 27/14; G02B 5/00

(52) U.S. Cl. CPC G02B 27/144; H04M 1/0266; G02B 5/003

(57) ABSTRACT

A screen frame is provided with a light-transmitting member, and the light-transmitting member absorbs or reflects light, such that a light flux passing through the light-transmitting member is less than a light flux of incident light in the same direction. The screen frame keeps the structural integrity of the screen frame on the premise of realizing the original functions of the screen frame, thereby optimizing the stability and simplifying the processing technology.

### CROSS-REFERENCE TO RELATED APPLICATION

The present application claims priority to Chinese Patent Application No. 201910101420.1 filed on Jan. 31, 2019, the disclosure of which is hereby incorporated by reference in its entirety.

### BACKGROUND

A screen frame is an important component in a terminal equipment and is used for fixing a screen and function modules around the screen. Typically, the screen frame is an opaque structure to shield portions of the terminal other than a display screen. Therefore, when the function modules include an optical sensor, the function modules are provided on the screen frame through an opening to guarantee the normal use of the optical sensor.

### SUMMARY

The present disclosure relates generally to the field of electronic device technologies, and more specifically to a screen frame, a display screen module, and a terminal.

Various embodiments of the present disclosure provide a screen frame, a display screen module and a terminal.

According to a first aspect of the present disclosure, a screen frame is provided, wherein the screen frame is provided with a light-transmitting member, and

the light-transmitting member absorbs or reflects light so that a light flux passing through the light-transmitting member is less than a light flux of incident light.

In some embodiments, an absorption rate or a reflection rate for the incident light of the light-transmitting member is greater than a transmission rate for the incident light.

In some embodiments, the light-transmitting member is provided at an edge of the screen frame.

In some embodiments, the light-transmitting member is provided in a light-transmitting region of the screen frame; the light-transmitting region of the screen frame is at least one of the following:

an opening region in the screen frame; and

a region made of a light-transmitting material in the screen frame.

In some embodiments, the light-transmitting member includes: a light-transmitting shielding layer, reflecting or absorbing light, and a transparent substrate bearing the light-transmitting shielding layer and connected with the screen frame.

In some embodiments, the light-transmitting shielding layer is coated on a surface of the transparent substrate; alternatively, the light-transmitting shielding layer is sandwiched inside two transparent substrates.

In some embodiments, the light-transmitting member includes a peep-hole lens.

According to a second aspect of the present disclosure, a screen module is provided, including: a display panel and the screen frame provided in the first aspect; the display panel is connected with the screen frame.

According to a third aspect of the present disclosure, a terminal is provided including an optical sensor, and the screen frame provided in the first aspect above. The optical sensor is located below the screen frame, and a light sensing surface of the optical sensor is provided corresponding to the light-transmitting member in the screen frame.

In some embodiments, the terminal includes at least two optical sensors, and the light-transmitting member covers light-sensing surfaces of the at least two optical sensors.

In some embodiments, the terminal further includes:

a light transmitting side edge,

the light-transmitting piece, provided corresponding to the light-transmitting side edge; and,

an optical sensor, corresponding to the light-transmitting member located at the light-transmitting side edge.

In some embodiments, the optical sensor is selected from at least one of the following: a structured light module, an optical fingerprint recognition module, an optical distance monitoring module, and a camera module.

### BRIEF DESCRIPTION OF THE DRAWINGS

The accompanying drawings, which are incorporated in the specification and constitute a part of the specification, show exemplary embodiments of the present disclosure. The drawings along with the specification explain the principles of the present disclosure.

FIG. 1 is a schematic diagram of a screen frame in the related art;

FIG. 2 is a first schematic diagram illustrating structures of screen frames according to some embodiments of the present disclosure;

FIG. 3 is a second schematic diagram illustrating structures of screen frames according to some embodiments of the present disclosure;

FIG. 4 is a third schematic diagram illustrating structures of screen frames according to some embodiments of the present disclosure;

FIG. 5 is a schematic diagram showing a principle of use of a light-transmitting member according to an exemplary embodiment;

FIG. 6 is a first schematic diagram illustrating structures of light-transmitting members according to various embodiments;

FIG. 7 is a second schematic diagram illustrating structures of light-transmitting members according to various embodiments;

FIG. 8 is a third schematic diagram illustrating structures of light-transmitting members according to various embodiments;

FIG. 9 is a schematic diagram showing a structure of a display screen module according to an exemplary embodiment; and

FIG. 10 is a schematic diagram showing a structure of a terminal according to an exemplary embodiment.

### DETAILED DESCRIPTION

Exemplary embodiments will be described in detail herein, examples of which are illustrated in the accompanying drawings. The following description refers to the same or similar elements in the different figures unless otherwise indicated. The embodiments described in the following exemplary embodiments do not represent all embodiments consistent with the present disclosure. Instead, they are merely examples of devices and methods consistent with aspects of the disclosure as indicated in the appended claims.

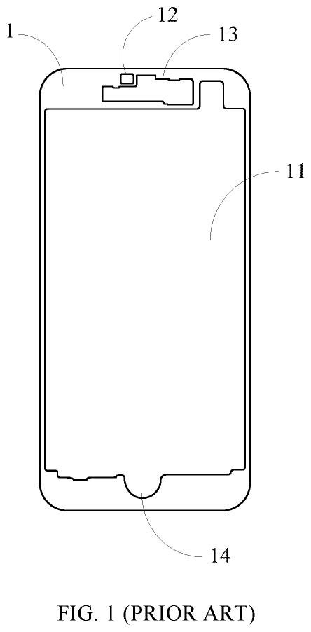

FIG. 1 is a schematic diagram of a screen frame provided in the related art.

Generally, when assembling a terminal device, a display screen and function modules are mounted on a screen frame. Since an internal structure of the terminal needs to be shielded, the whole screen frame is opaque. However, when an optical function module is installed, it is necessary to ensure smooth light passing, so the screen frame in the related art has the following structural features:

The various device components, units, blocks, or portions may have modular configurations, or are composed of discrete components, but nonetheless can be referred to as “modules” in general. In other words, the “components,” “modules” or “units” referred to herein may or may not be in modular forms.

As shown in FIG. 1, the screen frame 1 includes four sides, the four sides are enclosed to form the mounting region 11 where the display screen is mounted. The screen frame 1 is provided with a hole 12, and a groove 13 is formed at the edge of the screen frame 1. The function modules are mounted at the hole 12 and the groove 13.

The display screen can include a liquid crystal display (LCD) and a touch panel (TP). In some embodiments, the screen can be other types of displays, such as organic light-emitting diode (OLED) displays.

By removing a part of the screen frame 1, a mounting region for the function modules, in particular the function module with an optical sensor, is formed, whereby light can be directly received by the optical sensor without penetrating the screen frame 1.

When using the screen frame provided in the related art, the inventors have discovered the following problems.

Since the screen frame 1 is provided with a hole 12 or a groove 13 formed at the edge of the screen frame 1, the problems of stress concentration and the like are easy to occur, which affects the structural stability of the screen frame. Moreover, for the mounting stability, the hole 12 and the groove 13 usually have a plurality of layers in the thickness direction of the screen frame 1, for example, the hole 12 is a variable-diameter hole along the thickness direction of the screen frame 1. Therefore, the manufacture difficulty of the screen frame 1 is increased, and the equipment cost is increased.

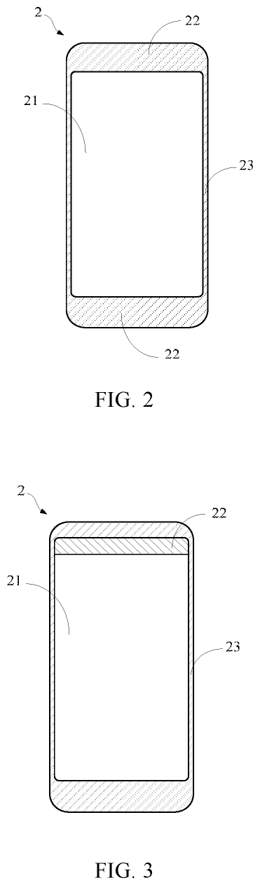

Based on the above problems, an embodiment of the present disclosure provides a screen frame. FIG. 2 is a schematic diagram showing a structure of a screen frame according to an exemplary embodiment, and FIG. 3 is a schematic diagram showing a principle of a use state of a screen frame according to an exemplary embodiment.

As shown in FIG. 2, the screen frame 2 provided by the embodiment of the present disclosure is formed with a mounting region 21 for mounting a screen. In some embodiments, the shape of the mounting region 21 is adapted to a shape of the display screen to be mounted.

The screen frame 2 also includes a light-transmitting member 22. As for the arrangement position of the light-transmitting member 22, as shown in FIG. 2, the light-transmitting member 22 is optionally located on at least one side edge of the screen frame. For example, the light-transmitting member 22 is located at the edge of the upper end of the screen frame 2. When assembled in the terminal, a light-transmitting strip or aperture on the display surface is formed by the light-transmitting member 22.

Further, the light-transmitting member 22 is optionally a part of the screen frame 2. For example, the light-transmitting member 22 is located on at least one side of the screen frame 2 in the longitudinal direction. Alternatively, the screen frame 2 as a whole is optionally a light-transmitting member 22. Alternatively, the screen frame 2 further includes a support member 23 connected to the light-transmitting member 22, and the light-transmitting member 22 and the support member 23 are connected to form the mounting region 21.

In some embodiments, the light-transmitting member 22 is provided at a light transmitting region of the screen frame. The light-transmitting region can include one or more of the following implementations.

In an implementation, the light-transmitting region is an opening region in the screen frame 2. First, it should be noted that openings are usually required to be respectively corresponding to different optical sensors on the screen frame in the related art. However, when the screen frame 2 provided by the embodiment of the present disclosure is adopted, the opening with a larger size may be optionally provided, so that the opening corresponds to a plurality of optical sensors. Hereby, the number of the openings in the screen frame 2 is also reduced.

In particular, as a preferable example, as shown in FIG. 3, the mounting region 21 for mounting the screen in the screen frame 2 includes the light-transmitting region. The mounting region 21 can optionally have a size larger than the screen to be mounted, and a portion of the mounting region 21 beyond the screen to be mounted forms a light-transmitting region. Accordingly, the transparent region is formed by the necessary mounting region 21 in the screen frame 2, and the number of the openings in the screen frame 2 is further reduced.

In this way, the screen frame 2 itself optionally does not include a light-transmitting material. For example, the screen frame 2 is a metal frame, a ceramic frame, or the like.

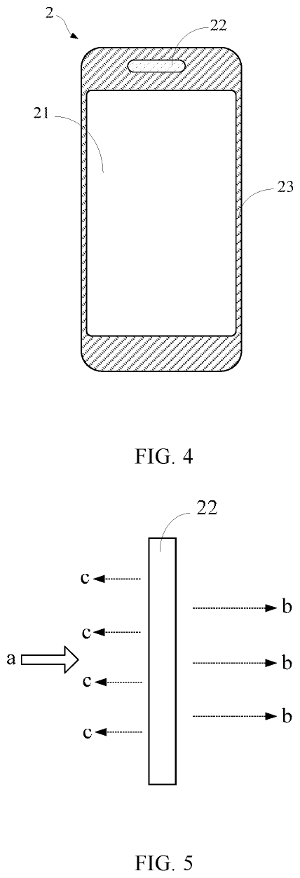

In an implementation, as shown in FIG. 4, the light-transmitting region is a region formed by light-transmitting material in the screen frame 2. For example, the screen frame 2 includes a transparent substrate and an opaque film layer coated on the transparent substrate, and the transparent substrate of the screen frame 2 forms the light-transmitting region in a region where the opaque film layer is not provided.

It is understood that the light-transmitting member 2 provided in the light-transmitting region of the screen frame 2 can allow light to pass. Therefore, even if the optical sensor is placed below the light-transmitting member 22, the optical sensor can be maintained in operation with the light penetrating the light-transmitting member 22.

In other words, the screen frame 2 satisfies the use requirement of the optical sensor matched with the screen frame 2 on the premise of maintaining the structural integrity, thereby the structural stability of the screen frame 2 is optimized and the manufacturing process thereof is simplified.

Further, the light-transmitting member 22 has the ability to absorb or reflect light, and by absorbing or scattering light, the light flux passing through the light-transmitting member 22 is made smaller than the light flux of incident light in the same direction. Thus, the light-transmitting member 22 can shield the structure below the light-transmitting member 2, and has the shielding performance of the screen frame at the same time.

In some embodiments, the light-transmitting member 22 has an absorption or reflection rate for incident light greater than a transmittance rate for incident light. Therefore, the shielding performance of the light-transmitting member 22 is further enhanced, the appearance of the terminal is optimized, and the requirements of users are met.

For example, when the light-transmitting member 22 absorbs the incident light, among the light incident on the side of the light-transmitting member 22, the light intensity of the light penetrating the light-transmitting member 22 is weaker than the light intensity of the light absorbed by the light-transmitting member 22. It can be understood that when one side of the light-transmitting member 22 has high ambient light brightness and another side has low ambient light brightness, it is difficult to observe one side of the light-transmitting member 22 from another side of the light-transmitting member 22 with the high ambient light brightness, that is, the shielding performance of the light-transmitting member 22 can be realized.

In addition, in this case, the light-transmitting member 22 can optionally be a heat-insulating film.

For example, when the light-transmitting member 22 reflects the incident light, referring to FIG. 5, the light a is incident from one side of the light-transmitting member 22, the first light b among the light a passes through the light-transmitting member 22, and the second light c among the light a is reflected by the light-transmitting member 22. Since the reflection rate of the light-transmitting member 22 is greater than the transmittance rate, the intensity of the second light c is greater than that of the first light b. It can be understood that when one side of the light-transmitting member 22 has high ambient light brightness and another side has low ambient light brightness, it is difficult to observe one side of the light-transmitting member 22 from another side of the light-transmitting member 22 with the high ambient light brightness, that is, the shielding performance of the light-transmitting member 22 is realized.

Moreover, the light-transmitting member 2 can present a mirror image at the side with the high ambient light brightness through the reflected second light c. For example, when the screen frame is applied to the terminal device, the screen frame 2 presents a mirror image at the external environment of the terminal through the second light c reflected by the light-transmitting member 22, further blocking the user experience brought by the screen frame.

In addition, in this case, the light-transmitting member 22 can be a peep-hole lens, by applying the characteristic that intensity of the ambient light inside the terminal is weak, the screen frame 2 can maintain an intact structure with light-transmitting performance and shielding performance.

It should be noted that, in general, the screen frame 2 is applied to a terminal, and one side of the screen frame 2 faces the inside of the terminal. Obviously, the ambient light intensity inside the terminal is significantly weaker than the ambient light intensity of the service space outside the terminal. Therefore, in such a case, the screen frame 2 provided by the present disclosure has the light-transmitting performance and the shielding performance with the light-transmitting member 22.

As such, the screen frame 2 provided by the embodiments of the disclosure can improve the integrity of the structure with the light-transmitting member 22 while realizing the original function of the screen frame, reduce the structures such as the light-transmitting holes and the grooves formed on the screen frame 2, and is beneficial to improving the structural stability of the screen frame, and simplifying the processing process of the screen frame 2.

In addition, it should be noted that, in the embodiments of the present disclosure, the specific characterization index of the light intensity is not limited, such as illuminance, power, and the like.

In one embodiment, the light-transmitting member 22 includes: a transparent substrate 221, and a light-transmitting shielding layer 222 provided on the transparent substrate 221. Among the light incident on the side of the light-transmitting member 22, the light-transmitting shielding layer 222 allows a part of the light to pass, and a part of the light to be reflected or absorbed, realizing the shielding performance and the light-transmitting performance of the light-transmitting member 22. Wherein, the transparent substrate 221 and the light-transmitting shielding layer 222 have the following optional arrangement.

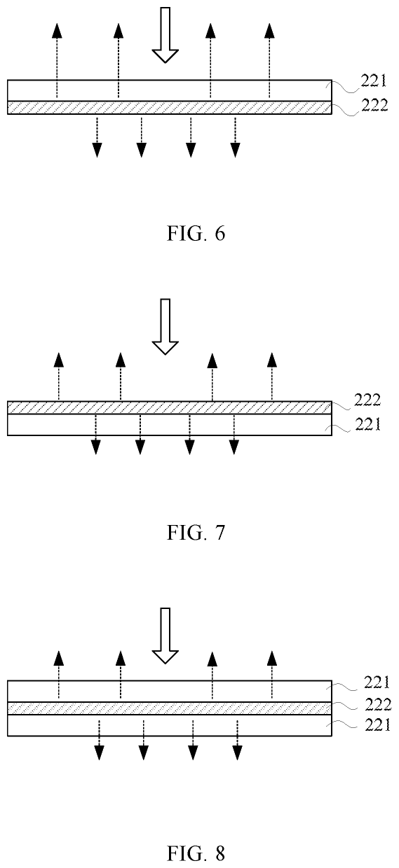

In the first arrangement, as shown in FIG. 6, the light-transmitting shielding layer 222 is coated on the surface of the side of the transparent substrate 221 facing away from the optical sensor. Accordingly, the light-transmitting shielding layer 222 is directly exposed to the outside, and incident light can be reflected or absorbed without penetrating the transparent substrate 221.

In the second arrangement, as shown in FIG. 7, the light-transmitting shielding layer 222 is coated on the surface of the side of the transparent substrate 221 facing the optical sensor.

In this case, when the light-transmitting shielding layer 222 realizes the shielding effect mainly by reflecting the light, the light reflected by the light-transmitting shielding layer 222 passes through the transparent substrate 221 and exits from the light-transmitting member 22. Accordingly, the transparent substrate 221 is optionally a transparent substrate having a predetermined color. Further, the light-transmitting member 22 exhibits a predetermined color by the reflection of the light-transmitting shielding layer 222, enriching the display effect of the screen frame 2.

In a case that the screen frame 2 is applied to a terminal, the transparent substrate 221 faces the outside of the terminal, the light-transmitting shielding layer 222 is located inside the terminal, and the light-transmitting shielding layer 222 is protected from interference by the transparent substrate 221.

In the third arrangement, as shown in FIG. 8, the light-transmitting shielding layer 222 is formed inside the transparent substrate 221. In some embodiments, the light-transmitting member 2 includes two transparent substrates 221 provided opposite to each other, and the light-transmitting shielding layer 222 is provided between the two transparent substrates 221. The transparent substrate 221 ensures that both sides of the light-transmitting shielding layer 222 located inside and outside of the terminal is from interference respectively, and is stably provided inside the transparent substrate 221.

In some embodiments, the transparent substrate 221 on the side of the light-transmitting shielding layer 222 facing away from the optical sensor is a colored transparent body having the predetermined color, so that the light-transmitting member 22 exhibits a predetermined color.

In these embodiments, the transparent substrate 221 can be selected from a glass substrate, a resin substrate, and the like. The light-transmitting shielding layer 222 can be selected from a resin film layer, a paint layer, a metal layer, or the like. In some embodiments, the light-transmitting shielding layer 222 is formed on the transparent substrate 221 by plating, spraying, injection molding, or the like. In particular, when the transparent substrate 221 and the light-transmitting shielding layer 222 are both resin materials, the light-transmitting member 22 can be manufactured by a two-material injection molding integral process.

In some other embodiments, the light-transmitting member 22 can have a single-layer structure, for example, the light-transmitting member 22 can be a translucent resin plate member or the like.

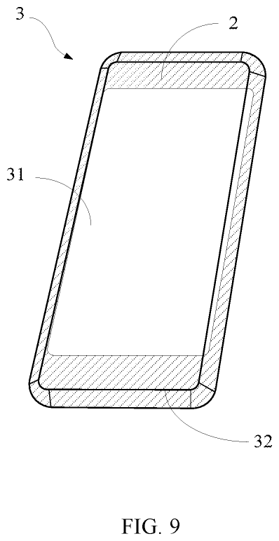

In a second aspect, various embodiments of the disclosure provide a display screen module. As shown in FIG. 9, the display screen module 3 includes: a cover plate 32 and the screen frame 2 provided in the above first aspect. Moreover, the display screen module 3 further includes a display screen 31 mounted in the mounting region 21 of the screen frame 2, such as by embedding or gluing. The cover plate 32 is overlaid on the display screen 31 and the screen frame 2.

Alternatively, the cover plate 32 can include a first cover plate covering the screen frame 2 and a second cover plate covering the display screen 31. Wherein the light-transmitting member 22 is optionally formed on the first cover plate. In such a case, it is necessary to make the portion of the screen frame 2 corresponding to the light-transmitting member 22 be a light-transmitting region.

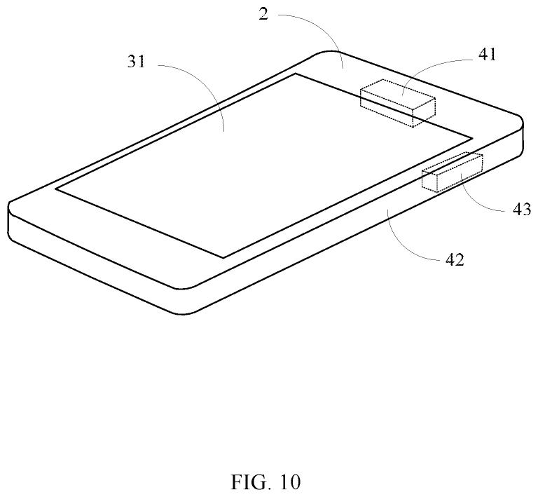

In a third aspect, various embodiments of the present disclosure provide a terminal. As shown in FIG. 10, the terminal 4 includes an optical sensor 41, and the screen frame 2 provided in the first aspect or the display screen module 3 provided in the second aspect. The optical sensor 41 is provided correspondingly to the light-transmitting member 22 of the screen frame 2.

According to the explanation of the first aspect, the light-transmitting member 22 in the screen frame 2 has both the light-transmitting function and the shielding function, so that the optical sensor 41 located below the light-transmitting member 22 in the embodiment of the disclosure can also receive and emit light signals. Further, the optical sensor 41 below the light-transmitting member 22 is hard to be observed from the outside of the terminal 4, thereby providing privacy shielding. And this screen frame 2 has the less quantity and even need not to set up structures such as light trap, groove, which optimizes the structural stability of screen frame 2, and simplifies the manufacture flow of screen frame 2.

In some embodiments, the terminal 4 includes at least two optical sensors 41, and the light-transmitting member 22 covers light sensing surfaces of the at least two optical sensors 41. By providing one light-transmitting member 22, the normal operations of the plurality of optical sensors 41 can be met to reduce the number of the openings in the structure of the terminal.

In some embodiments, the terminal 4 further includes a light-transmitting side 42. In some embodiments, the side edge 42 is a part of the rear cover of the terminal. For example, the edge of the rear cover extends upward to form the side 42. At this time, the rear cover is also a transparent component, such as an acrylic rear cover.

In some embodiments, the side 42 is an individual component of the terminal 4, which is connected to the rear cover and the screen frame 2 when assembled.

Moreover, the light-transmitting member 22 described in the first aspect is provided inside the side edge 42. It should be noted that, in the present embodiment, the light-transmitting member 22 optionally includes a transparent substrate 221 and a light-transmitting shielding layer 222 provided on the transparent substrate 221. Alternatively, the light-transmitting member 22 optionally includes only the light-transmitting shielding layer 222, and at this time, the light-transmitting shielding layer 222 is supported by the light-transmitting side 42 instead of the transparent substrate 221.

The terminal 4 can further include an optical sensor 43 provided corresponding to the light-transmitting member 22 located on the side 42. Accordingly, the light-transmitting side 42 and the light-transmitting member 22 enable the side 42 of the terminal 4 to achieve the matching with the optical sensor 43 while maintaining the side structure intact. Moreover, the current terminal exhibits the feature of being light and thin, and the thickness of the side of the terminal is small. In such a case, the structural stability of the side is improved since it is not necessary to provide a light-transmitting hole at the side 42, thereby the stability and durability of the overall structure of the terminal is optimized.

In the terminal provided by the embodiments of the present disclosure, the optical sensors (41 and 43) can be selected from sensors in any of the following function modules: a structured light module, an optical fingerprint recognition module, and an optical distance monitoring module.

Different functions can be realized based on the cooperation of the optical sensors (41 and 43) with the transparent member 11. Moreover, in such a case, a plurality of light-transmitting holes is not required to be provided, and the structural stability and the richness of the functions of the terminal are considered. This is explained in detail below in connection with specific examples.

By way of example, the optical sensors (41 and 43) are sensors in the distance monitoring module. The distance from the target object outside the terminal to the side 42 can be monitored by the optical sensors (41 and 43).

By way of example, the optical sensors (41 and 43) are sensors in the fingerprint recognition module. Fingerprint characteristics of the target object placed at a preset position of the terminal can be identified by the optical sensors (41 and 43), and then specified functions such as unlocking, payment, photographing and the like are triggered.

It is understood that, in the present embodiment, the light-transmitting member 22 is made to cover the plurality of sensors (41 and 43) so that the normal use of the plurality of sensors (41 and 43) can be satisfied.

Various embodiments of the present disclosure can have one or more of the following advantages.

The screen frame provided by some embodiments of the present disclosure enables light to penetrate through the light-transmitting member. Therefore, when the screen frame is matched with the optical sensor, the light penetrating through the light-transmitting piece can be received by the optical sensor so as to maintain the use of the optical sensor. Moreover, the light-transmitting member plays a certain shielding role in absorbing or reflecting light, realizing the shielding effect of the frame. The screen frame used in the embodiment of the present disclosure reduces the opening on the screen frame through the light-transmitting member, improves the structural stability of the screen frame, and simplifies the manufacturing process.

It should be understood that “a plurality of” mentioned herein means two or more. The term “and/or” describes the association relationship of associated objects, indicating that there may be three relationships. For example, A and/or B may indicate that there are three cases: A exists only, both A and B exist, and B exists only. The character “/” generally indicates that the contextual objects are in an “or” relationship. As used herein, “connected” may mean directly connected or indirectly connected.

While this specification contains many specific implementation details, these should not be construed as limitations on the scope of any claims, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombinations.

Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

As such, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing can be utilized. Some other embodiments of the present disclosure can be available to those skilled in the art upon consideration of the specification and practice of the various embodiments disclosed herein.

The present application is intended to cover any variations, uses, or adaptations of the present disclosure following general principles of the present disclosure and include the common general knowledge or conventional technical means in the art without departing from the present disclosure. The specification and examples can be shown as illustrative only, and the true scope and spirit of the disclosure are indicated by the following claims. In the present disclosure, it is to be understood that the terms “bottom,” “inside,” and other orientation or positional relationships are based on example orientations illustrated in the drawings, and are merely for the convenience of the description of some embodiments, rather than indicating or implying the device or component being constructed and operated in a particular orientation. Therefore, these terms are not to be construed as limiting the scope of the present disclosure.

It will be understood that, although the terms first, second, etc. can be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or other structure is referred to as being “on” or extending “onto” another element, it can be directly on or extend directly onto the other element or intervening elements can also be present. In contrast, when an element is referred to as being “directly on” or extending “directly onto” another element, there are no intervening elements present.

Likewise, it will be understood that when an element such as a layer, region, or substrate is referred to as being “over” or extending “over” another element, it can be directly over or extend directly over the other element or intervening elements can also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements can be present. In contrast, when an element is referred to as being “directly connected” or “directly coupled” to another element, there are no intervening elements present.

Relative terms such as “below” or “above” or “upper” or “lower” or “vertical” or “horizontal” can be used herein to describe a relationship of one element, layer, or region to another element, layer, or region as illustrated in the drawings. It will be understood that these terms and those discussed above are intended to encompass different orientations of the device in addition to the orientation depicted in the drawings.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In the description of the present disclosure, the terms “some embodiments,” “example,” and the like may indicate a specific feature described in connection with the embodiment or example, a structure, a material or feature included in at least one embodiment or example. In the present disclosure, the schematic representation of the above terms is not necessarily directed to the same embodiment or example.

Moreover, the particular features, structures, materials, or characteristics described may be combined in a suitable manner in any one or more embodiments or examples. In addition, various embodiments or examples described in the specification, as well as features of various embodiments or examples, may be combined and reorganized.

It is intended that the specification and embodiments be considered as examples only. Other embodiments of the disclosure will be apparent to those skilled in the art in view of the specification and drawings of the present disclosure. That is, although specific embodiments have been described above in detail, the description is merely for purposes of illustration. It should be appreciated, therefore, that many aspects described above are not intended as required or essential elements unless explicitly stated otherwise.

Various modifications of, and equivalent acts corresponding to, the disclosed aspects of the example embodiments, in addition to those described above, can be made by a person of ordinary skill in the art, having the benefit of the present disclosure, without departing from the spirit and scope of the disclosure defined in the following claims, the scope of which is to be accorded the broadest interpretation so as to encompass such modifications and equivalent structures.

1. A screen frame, comprising a light-transmitting member;
wherein the light-transmitting member is configured to absorb and/or reflect light, such that a light flux passing through the light-transmitting member is less than a light flux of incident light.

2. The screen frame of claim 1, wherein an absorption rate or a reflection rate for the incident light of the light-transmitting member is greater than a transmission rate for the incident light.

3. The screen frame of claim 1, wherein the light-transmitting member is provided at an edge of the screen frame.

4. The screen frame of claim 1, wherein the light-transmitting member is provided in a light-transmitting region of the screen frame; and the light-transmitting region of the screen frame comprises at least one of:
an opening region in the screen frame; or
a region made of a light-transmitting material in the screen frame.

5. The screen frame of claim 4, wherein the light-transmitting member blocks the opening structure and the light-transmitting member is aligned with a region around the opening.

6. The screen frame of claim 1, wherein the light-transmitting member comprises:
a light-transmitting shielding layer, reflecting or absorbing light; and
a transparent substrate, bearing the light-transmitting shielding layer and connected with the screen frame.

7. The screen frame of claim 6, wherein the light-transmitting shielding layer is coated on the surface of the transparent substrate;
or, the light-transmitting shielding layer is sandwiched inside two transparent substrates.

8. The screen frame of claim 1, wherein the light-transmitting member includes a peep-hole lens.

9. A display screen module comprising: a display panel, and the screen frame of claim 1; wherein the display panel is connected with the screen frame.

10. A terminal, comprising an optical sensor and the screen frame of claim 1;
wherein the optical sensor is located below the screen frame, and a light sensing surface of the optical sensor is provided corresponding to the light-transmitting member in the screen frame; and
wherein the optical sensor is configured to function based on the light flux passing through the light-transmitting member.

11. The terminal of claim 10, wherein the terminal includes at least two optical sensors, and the light-transmitting member covers light-sensing surfaces of the at least two optical sensors.

12. The terminal of claim 10, wherein the terminal further comprises:
a light transmitting side edge,
the light-transmitting member, provided corresponding to the light transmitting side edge; and
an optical sensor, corresponding to the light-transmitting member located at the light-transmitting side edge.

13. The terminal of claim 10, wherein the optical sensor selected from at least one of the following: a structured light module, an optical fingerprint recognition module, an optical distance monitoring module, and a camera module.

14. A display screen module, comprising: a display panel, and the screen frame of claim 2; the display panel is connected with the screen frame.

15. A display screen module, comprising: a display panel, and the screen frame of claim 3; the display panel is connected with the screen frame.

16. A display screen module, comprising: a display panel, and the screen frame of claim 4; the display panel is connected with the screen frame.

17. A terminal, comprising: an optical sensor and the display screen module of claim 9;
wherein the optical sensor is located below the screen frame, and a light sensing surface of the optical sensor is provided corresponding to the light-transmitting member in the screen frame.

18. A terminal, comprising: an optical sensor, and the screen frame of claim 2;
wherein the optical sensor is located below the screen frame, and a light sensing surface of the optical sensor is provided corresponding to the light-transmitting member in the screen frame.

19. A terminal, comprising: an optical sensor, and the screen frame of claim 3;
wherein the optical sensor is located below the screen frame, and a light sensing surface of the optical sensor is provided corresponding to the light-transmitting member in the screen frame.

20. A terminal, comprising: an optical sensor, and the screen frame of claim 4;
wherein the optical sensor is located below the screen frame, and a light sensing surface of the optical sensor is provided corresponding to the light-transmitting member in the screen frame.
